(19) United States
(12) Patent Application Publication
(10) Pub. No.: US 2010/0111524 A1
(43) Pub. Date: May 6, 2010

(54) METHOD AND TERMINAL FOR TRANSMITTING DATA

(76) Inventor: Yang Yu, Beijing (CN)

Correspondence Address: LADAS & PARRY LLP, 224 SOUTH MICHIGAN AVENUE, SUITE 1600, CHICAGO, IL, 60604, US

(21) Appl. No.: 12/594,882

(22) PCT Filed: Dec. 21, 2007
(86) PCT No.: PCT/CN07/71308

§ 371 Date: Oct. 6, 2009

(30) Foreign Application Priority Data
Apr. 6, 2007 (CN) 200710090424.1

(51) Int. Cl. H04B 10/24

(52) U.S. Cl. 398/41

(57) ABSTRACT

Embodiments of the present invention provide a method for transmitting data, a Coaxial-cable Line Terminal (CLT) and a Coaxial-cable Network Unit (CNU). The method, applicable to a coaxial network including at least one Coaxial-cable Line Terminal (CLT) and multiple Coaxial-cable Network Units (CNUs), the CLT being connected with each of the CNUs through a shared coaxial medium, includes: transmitting, by the CLT, a control message to each of the CNUs. The control message contains information of an uplink transmission period of time that can be occupied by each CNU during one period, and uplink transmission periods of time for the CNUs are not overlapped with one another so that uplink data transmitted by the CNUs do not collide with each other. The embodiments of the present invention allocate a shared transmission medium in an EPCN system, and guarantee normal physical layer communications of the EPCN system.

### FIELD OF THE INVENTION

The present invention relates to Ethernet communication technologies, and more particularly, to a method and terminal for transmitting data.

### BACKGROUND OF THE INVENTION

Ethernet Passive Optical Network (EPON) refers to an access technique which combines passive optical network techniques with Ethernet techniques. An EPON system mainly includes an Optical Line Terminal (OLT), an Optical Distributed Network (ODN) and an Optical Network Unit (ONU). The OLT is connected with one or more ODNs. The ODN is a passive optical distribution apparatus. The ODN transmits downlink data from the OLT to multiple ONUs through optical branches, and converges and transmits uplink data from the ONUs to the OLT. The transmission of the data adopts a passive optical fiber transmission manner.

Based on the structure of the EPON system, an Ethernet Passive Coaxial-cable Network (EPCN) system emerges currently. The EPCN system is running on an Ethernet and adopts a point-to-multipoint structure. FIG. 1 is a schematic diagram illustrating a structure of an EPCN system. As shown in FIG. 1, the EPCN system mainly includes a Coaxial-cable Line Terminal (CLT), a branch/distributor and a Coaxial-cable Network Unit (CNU). The EPCN system connects various Ethernet apparatuses through the CLT and connects user equipment through the CNU. The EPCN system may be applied to multiple services. The most popular is an application of Ethernet wideband to doors in a building.

The EPCN system adopts a point-to-multipoint structure, i.e. a structure from one CLT to multiple CNUs. The CLT exchanges data with the CNUs through a coaxial cable. The CLT occupies a downlink direction of the coaxial cable and the CNUs share an uplink direction of the coaxial cable. As can be seen from characteristics of the EPCN system, because the CNUs share the uplink direction of the coaxial cable, i.e. each CNU has to transmit data to the CLT through the same physical medium, it is necessary to ensure that the data transmitted by the CNUs do not collide with each other in order to ensure that the CLT can receive the uplink data transmitted by each CNU correctly. Currently, there is no such solution which can avoid the collision of the uplink data transmitted by the CNUs.

### SUMMARY OF THE INVENTION

Embodiments of the present invention provide a method for transmitting data, a Coaxial-cable Line Terminal (CLT) and a Coaxial-cable Network Unit (CNU), which can ensure that uplink data transmitted by CNUs do not collide with each other.

According to an embodiment of the present invention, a method for transmitting data is provided. The method, applicable to a coaxial network comprising at least one Coaxial-cable Line Terminal (CLT) and multiple Coaxial-cable Network Units (CNUs), the CLT being connected with each of the CNUs through a shared coaxial medium, includes: transmitting, by the CLT, a control message to each of the CNUs, wherein the control message contains information of an uplink transmission period of time that can be occupied by each CNU during one period, and uplink transmission periods of time for the CNUs are not overlapped with one another so that uplink data transmitted by the CNUs do not collide with each other.

According to another embodiment of the present invention, a CNU is provided. The CNU is located in a coaxial network including at least one Coaxial-cable Line Terminal (CLT) and multiple CNUs and the CLT being connected with each of the CNUs through a shared coaxial medium. The CNU includes:

a downlink data receiving unit, a control unit and an uplink data transmitting unit;

wherein the downlink data receiving unit is adapted to receive downlink data and a control message transmitted by the CLT;

the control unit is in a Media Access Control (MAC) layer and is adapted to obtain a periodical uplink transmission period of time from the control message transmitted by the CLT, control the uplink data transmitting unit during the uplink transmission period of time in one period to start to transmit uplink data to the CLT, and control the uplink data transmitting unit during other time of the period to close and stop transmitting the uplink data so as to avoid collision with data transmitted by other CNUs.

According to another embodiment of the present invention, a CLT is provided. The CLT is located in a coaxial network including at least the CLT and multiple Coaxial-cable Network Units (CNUs) and the CLT being connected with each of the CNUs through a shared coaxial medium. The CLT includes: a downlink data transmitting unit, a control unit, a transmission time allocating unit and an uplink data receiving unit;

wherein the uplink data receiving unit is adapted to receive uplink data transmitted by the CNUs;

the transmission time allocating unit is adapted to allocate a periodical downlink transmission period of time to the CLT and transmit a control message to each of the CNUs, wherein the control message contains information of an uplink transmission period of time that can be occupied by each CNU during one period and uplink transmission periods of time for the CNUs are not overlapped with one another so that uplink data transmitted by the CNUs do not collide with each other; and

the control unit is located in a Media Access Control (MAC) layer and adapted to control the downlink data transmitting unit in the periodical downlink transmission period of time to start to transmit downlink data to the CNUs, and control the downlink data transmitting unit during other time of the period to stop transmitting the downlink data to avoid collision with the uplink data transmitted by the CNUs.

As can be seen, through allocating the uplink occupation period of time for each CNU, the present invention allocates a shared transmission medium for the CNUs in the EPCN system and ensures that the uplink data transmitted by the CNUs does not collide with each other. The CLT can correctly receive the uplink data transmitted by each CNU, which guarantees normal physical layer communications in the EPCN system.

Furthermore, the present invention provides methods for allocating uplink and downlink occupation periods of time when the EPCN system works in a full-duplex mode and a semi-duplex mode, which not only guarantees uplink transmission of each CNU, but also guarantees that the downlink data transmitted by the CLT do not collide with the uplink data transmitted by the CNUs. Therefore, the normal physical layer communications of the EPCN system are further guaranteed and quality of service is dramatically improved.

### BRIEF DESCRIPTION OF THE DRAWINGS

FIG. 1 is a schematic diagram illustrating a structure of an EPCN system.

FIG. 2 is a flowchart illustrating a method for transmitting data in the EPCN system according to a first embodiment of the present invention.

FIG. 3 is a flowchart illustrating a method for transmitting data in the EPCN system according to a second embodiment of the present invention.

FIG. 4 is a schematic diagram illustrating an internal structure of a CLT according to an embodiment of the present invention.

FIG. 5 is a schematic diagram illustrating an internal structure of a CNU according to an embodiment of the present invention.

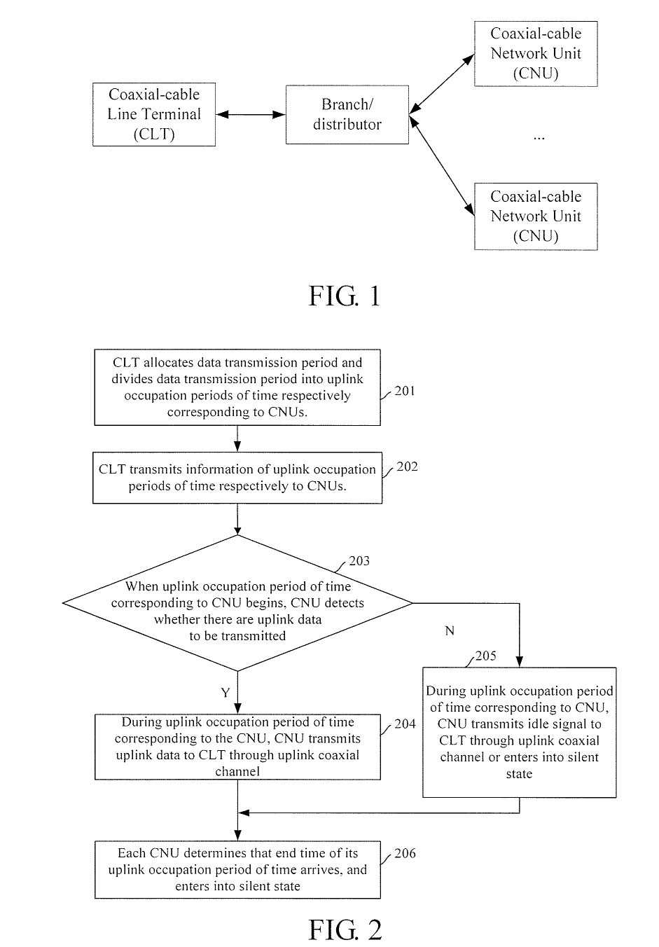

### DETAILED DESCRIPTION OF THE INVENTION

The present invention will be described in detail hereinafter with reference to accompanying drawings and embodiment to make the solution and merits therein clearer.

Embodiments of the present invention provide a method for transmitting data. In the method, an uplink occupation period of time is allocated to each CNU, and each CNU processes and transmits uplink data in its uplink occupation period of time.

It should be noted that, in practical service applications, from the perspective of sharing physical layer medium, the EPCN system may be a full-duplex system or a semi-duplex system. In the full-duplex system, the uplink direction and the downlink direction apply different physical layer channels. In other words, the downlink direction from the CLT to the CNUs occupies a downlink coaxial channel all the time and the uplink direction from the CNUs to the CLT occupies an uplink coaxial channel all the time. In the semi-duplex system, the downlink direction and the uplink direction share the same physical layer medium. In other words, the downlink direction from the CLT to the CNUs and the uplink direction from the CNUs to the CLT share an uplink/downlink shared coaxial cable in a time-division manner.

As can be seen, in the EPCN system, because the CLT and the CNUs may work in the full-duplex mode or the semi-duplex mode, it is necessary to consider the transmission characteristics in the full-duplex mode as well as the semi-duplex mode when allocating the uplink period of time to the CNUs. Hereinafter, embodiments are provided respectively for describing scenarios of the full-duplex mode and the semi-duplex mode.

### The First Embodiment

FIG. 2 is a flowchart illustrating data transmission in the EPCN system according to the first embodiment of the present invention. As shown in FIG. 2, when the EPCN system works in the full-duplex mode, data transmission according to an embodiment includes the following.

Step 201: The CLT allocates a data transmission period and divides the data transmission period into uplink occupation periods of time respectively corresponding to CNUs.

The EPCN system has a point-to-multipoint structure, i.e. one CLT is coupled to multiple CNUs. When the CLT and the CNUs in the EPCN system are all in the full-duplex mode, the data transmission in the downlink direction and that in the uplink direction occupy different coaxial channels. Therefore, the CLT may keep on transmitting downlink data without considering the period of time occupied by the CLT for transmitting the downlink data. Further, the CNUs share one uplink coaxial channel and it is therefore necessary to determine how often each CNU transmits uplink data once. Consequently, in this step, the CLT allocates the data transmission period occupied by all the CNUs to transmit uplink data once, and divides the data transmission period into the uplink occupation periods of time respectively corresponding to the CNUs. For example, the CLT may allocate the data transmission period of 10 ms and divide the 10 ms into uplink occupation periods of time respectively for the CNUs, e.g. CNU 1 occupies the first 1 ms in the data transmission period of 10 ms, and CNU 2 occupies the second 1 ms in the data transmission period of 10 ms, etc.

In this embodiment, Step 201 may be performed by a Media Access Control (MAC) layer of the CLT.

Step 202: The CLT transmits information of the uplink occupation periods of time respectively to the CNUs.

In Step 202, the CLT may transmit the information of the uplink occupation periods of time respectively to the CNUs through an existing or a newly-defined control message.

In addition, in this step, the transmission of the information of the uplink occupation periods of time respectively to the CNUs may be performed by a PHY layer of the CLT. After receiving the information of an uplink occupation period of time, a MAC layer of a CNU may store the information of the uplink occupation period of time.

Step 203: When the uplink occupation period of time corresponding to a CNU begins, the CNU detects whether there are uplink data to be transmitted. If there are uplink data to be transmitted, Step 204 is performed; otherwise, Step 205 is performed.

In Step 203, it may be the MAC layer of the CNU that determines the arrival of the uplink occupation period of time corresponding to the CNU according to the stored information of the uplink occupation period of time and sends a start indication to the PHY layer of the CNU. After receiving the start indication, the PHY layer of the CNU detects whether there are the uplink data to be transmitted.

Step 204: During the uplink occupation period of time corresponding to the CNU, the CNU transmits the uplink data to the CLT through the uplink coaxial channel and Step 206 is performed.

In this step, transmitting the uplink data to the CLT may be performed by the PHY layer of the CNU.

Step 205: During the uplink occupation period of time corresponding to the CNU, the CNU transmits an idle signal to the CLT through the uplink coaxial channel or enters into a silent state.

In this step, transmitting the idle signal to the CLT or entering into the silent state may be performed by the PHY layer of the CNU.

Step 206: Each CNU determines that end time of its uplink occupation period of time arrives, and enters into the silent state.

In this step, determining the end time of the uplink occupation period of time may be performed by the MAC layer of the CNU. The MAC layer of the CNU sends a close indication to the PHY layer of the CNU. The CNU enters into the silent state after the PHY layer of the CNU receives the close indication.

In the full-duplex mode, the uplink data and the downlink data may be transmitted at the same time. Therefore, the CLT is always processing and transmitting the downlink data, including: detecting, by the CLT in real time, whether there are the downlink data to be transmitted, if there are the downlink data to be transmitted, transmitting by the CLT the downlink data to the CNUs through the downlink coaxial channel; otherwise, transmitting by the CLT an idle signal to the CNUs through the downlink coaxial channel or entering into a silent state.

### The Second Embodiment

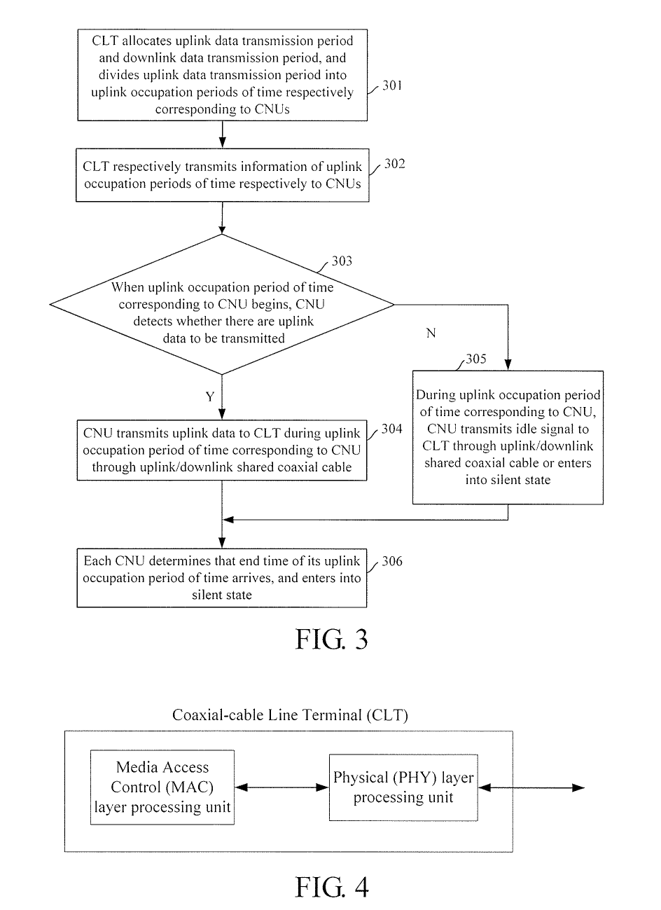

FIG. 3 is a flowchart illustrating the data transmission in the EPCN system according to the second embodiment of the present invention. As shown in FIG. 3, when the EPCN system works in the semi-duplex mode, the data transmission in another embodiment includes the following.

Step 301: The CLT allocates an uplink data transmission period and a downlink data transmission period, and divides the uplink data transmission period into uplink occupation periods of time respectively corresponding to the CNUs.

When the CLT and each of the CNUs in the EPCN system work in the semi-duplex mode, downlink data and uplink data are transmitted through the same coaxial cable. Therefore, the downlink data and the uplink data cannot be transmitted simultaneously but share the same coaxial cable in a time-division manner. Therefore, in this step, the CLT firstly allocates the uplink data transmission period for transmitting the uplink data and the downlink data transmission period for transmitting the downlink data. Then, the CLT divides the uplink data transmission period into uplink occupation periods of time respectively corresponding to the CNUs. For example, the CLT may allocate 5 ms for the downlink data transmission period and another 5 ms for the uplink data transmission period. Then the CLT divides the 5 ms into the uplink occupation periods of time for the CNUs, e.g. CNU1 occupies the first 1 ms in the 5 ms and CNU2 occupies the second 1 ms in the 5 ms, etc.

In this embodiment, Step 301 may be performed by a MAC layer of the CLT.

Step 302: The CLT transmits information of the uplink occupation periods of time respectively to the CNUs.

In Step 302: The information of the uplink occupation periods of time may be transmitted respectively to the CNUs by the CLT via an existing or a newly-defined control message.

In addition, in this step, it may be a PHY layer of the CLT that transmits the information of the uplink occupation periods of time from the MAC layer of the CLT respectively to the CNUs. After receiving the information of the uplink occupation periods of time, MAC layers of the CNUs may respectively store the information of the uplink occupation periods of time.

Step 303: When an uplink occupation period of time corresponding to a CNU begins, the CNU detects whether there are uplink data to be transmitted. If there are uplink data to be transmitted, Step 304 is performed; otherwise, Step 305 is performed.

In Step 303, it may be a MAC layer of the CNU that determines the arrival of the uplink occupation period of time corresponding to the CNU according to the stored information of the uplink occupation period of time and sends a start indication to a PHY layer of the CNU. After receiving the start indication, the PHY layer of the CNU detects whether there are the uplink data to be transmitted.

Step 304: The CNU transmits the uplink data to the CLT during the uplink occupation period of time corresponding to the CNU through the uplink/downlink shared coaxial cable and Step 306 is performed.

In this step, transmitting the uplink data to the CLT may be performed by the PHY layer of the CNU.

Step 305: During the uplink occupation period of time corresponding to the CNU, the CNU transmits an idle signal to the CLT through the uplink/downlink shared coaxial cable or enters into the silent state.

In this step, transmitting the idle signal to the CLT or entering into the silent state may be performed by the PHY layer of the CNU.

Step 306: Each CNU determines that end time of its uplink occupation period of time arrives, and enters into the silent state.

In this step, it may be the MAC layer of a CNU that determines the end time of its uplink occupation period of time arrives. Then the MAC layer of the CNU sends a close indication to the PHY layer of the CNU. The CNU enters into the silent state after the PHY layer of the CNU receives the close indication.

In the semi-duplex mode, the uplink data and the downlink data are transmitted in different time. When Steps 303 and 306 in FIG. 3 are performed, it is in the uplink data transmission period. Therefore, the CLT is in the silent state and does not transmit the downlink data. After the end of the uplink data transmission period, i.e. in the downlink data transmission period, the CLT processes and transmits the downlink data, including: when the downlink data transmission period starts, detecting by the CLT whether there are the downlink data to be transmitted, if there are the downlink data to be transmitted, transmitting by the CLT the downlink data to the CNUs through the uplink/downlink shared coaxial cable; otherwise, transmitting by the CLT an idle signal to the CNUs through the uplink/downlink shared coaxial cable or entering into the silent state.

It should be noted that, in the flowcharts illustrated in FIG. 2 and FIG. 3, the CLT may allocate an uplink occupation period of time to each CNU according to experience values. In other words, both allocating each data transmission period and allocating the uplink occupation periods of times respectively corresponding to the CNUs may be performed by the CLT according to the experience values pre-configured inside the CLT. For example, according to the experience values, the uplink data transmission period may be 5 ms and the downlink data transmission period may also be 5 ms.

Preferably, the CLT may also allocate the uplink occupation period of time for each CNU according to data reported by each CNU. In other words, in embodiments of the present invention, before transmitting the uplink data, each CNU may further transmit to the CLT the length of the uplink data to be transmitted. Consequently, the CLT may allocate each data transmission period mentioned in the above embodiments and allocate the uplink occupation period of time corresponding to each CNU according to the number of the CNUs and the length of the uplink data to be transmitted by each CNU.

Accordingly, an embodiment of the present invention also provides a CLT. FIG. 4 is a schematic diagram illustrating a structure of a CLT according to an embodiment of the present invention. As shown in FIG. 4, in an embodiment of the present invention, the CLT mainly includes: a MAC layer processing unit and a PHY layer processing unit.

The MAC layer processing unit is adapted to allocate an uplink occupation period of time for each CNU, and send information of the uplink occupation period of time corresponding to each CNU to the PHY layer processing unit.

The PHY layer processing unit is adapted to transmit the information of the uplink occupation period of time corresponding to each CNU from the MAC layer processing unit to each CNU.

As shown in FIG. 4, when the CLT works in the full-duplex mode, allocating the uplink occupation period of time corresponding to each CNU by the MAC layer processing unit may include: the MAC layer processing unit allocates a data transmission period, and divides the data transmission period into uplink occupation periods of time respectively corresponding to the CNUs.

When the CLT works in the semi-duplex mode, allocating the uplink occupation period of time corresponding to each CNU by the MAC layer processing unit may include: the MAC layer processing unit allocates an uplink data transmission period and a downlink data transmission period, and divides the uplink data transmission period into uplink occupation periods of time respectively corresponding to the CNUs.

As shown in FIG. 4, when the CLT works in the full-duplex mode, in order to implement downlink data transmission inside the CLT, the MAC layer processing unit may further keep sending a start indication to the PHY layer processing unit. The PHY layer processing unit performs the downlink data transmission through the downlink coaxial channel after receiving the start indication. In other words, the downlink transmission is always valid and the PHY layer processing unit can always detect the start indication. Therefore, if only there are downlink data, the PHY layer processing unit transmits the downlink data.

When the CLT works in the semi-duplex mode, in order to implement downlink data transmission inside the CLT, the MAC layer processing unit may further send a start indication to the PHY layer processing unit when detecting that the downlink data transmission period starts and send a close indication to the PHY layer processing unit when detecting that the downlink data transmission period ends. The PHY layer processing unit may further perform downlink data transmission through the uplink/downlink shared coaxial cable when receiving the start indication and enter into the silent state when receiving the close indication.

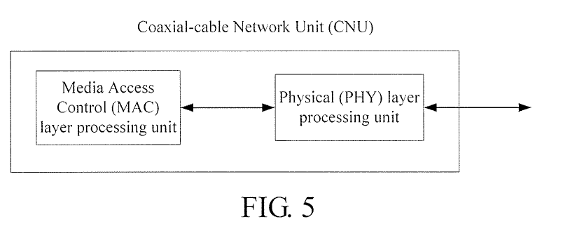

Accordingly, an embodiment of the present invention provides a CNU. FIG. 5 is a schematic diagram illustrating an internal structure of a CNU according to an embodiment of the present invention. As shown in FIG. 5, the CNU mainly includes a MAC layer processing unit and a PHY layer processing unit in an embodiment of the present invention.

The MAC layer processing unit is adapted to obtain an uplink occupation period of time corresponding to the CNU where the MAC layer processing unit is located, and send a start indication to the PHY layer processing unit when detecting that the uplink occupation period of time begins.

The PHY layer processing unit is adapted to perform uplink data transmission after receiving the start indication.

As shown in FIG. 5, the MAC layer processing unit is further adapted to send a close indication to the PHY layer processing unit when detecting that the uplink occupation period of time ends.

The PHY layer processing unit is further adapted to enter into the silent state after receiving the close indication.

As shown in FIG. 5, the uplink data transmission performed by the PHY layer processing unit includes: after receiving the start indication, the PHY layer processing unit transmits uplink data to the CLT if detecting that there are the uplink data to be transmitted, and transmits an idle signal to the CLT or enters into the silent state if detecting that there are no uplink data to be transmitted. Particularly, when the CNU works in the full-duplex mode, the uplink data or the idle signal is transmitted through the uplink coaxial channel. When the CNU works in the semi-duplex mode, the uplink data or the idle signal is transmitted through the uplink/downlink shared coaxial cable.

It should be noted that, in the above embodiments, it is the CLT that allocates the uplink occupation periods of time respectively to the CNUs and transmits information of the uplink occupation periods of time respectively to the CNUs. Thereby, each CNU may transmit the uplink data during its uplink occupation period of time. In other embodiments of the present invention, it may be a manager that directly allocates the uplink occupation periods of time on the CNUs so that each CNU may transmit the uplink data during its uplink occupation period of time.

Through the above description of the embodiments, those skilled in the art may clearly understand that the present invention may be implemented by software together with general computer equipment capable of running the software (may be comprehended as a general hardware platform). Certainly, the present invention may also be implemented by hardware. But in most cases, the former is a preferable implementation manner. Based on this, the essential part of the present invention or the part contributing to the prior art may be embodied in a software product. The software product is stored in a storage medium and includes several instructions to implement the solutions described in the embodiments of the present invention.

According to the above embodiments of the present invention, one kind of CNUs may be obtained. The CNUs are located in a coaxial network including at least one CLT and multiple CNUs. The CLT and each of the CNUs are connected with each other through a shared coaxial cable. Particularly, each CNU includes a downlink data receiving unit, a control unit and an uplink data transmitting unit.

The downlink data receiving unit is adapted to receive downlink data transmitted by the CLT.

The control unit is in the MAC layer, adapted to obtain a periodical uplink transmission period of time from the CLT, control the uplink data transmitting unit to start to transmit the uplink data to the CLT in the periodical uplink transmission period of time, and control the uplink data transmitting unit to close during other time of a period so as to stop transmitting the uplink data and avoid collision with data transmitted by other CNUs or the CLT.

The periodical uplink transmission period of time is not overlapped with the time when the CLT transmits the downlink data.

As to the CNU, in one period, the uplink transmission time occupied by the CNU may be shorter than the downlink transmission time occupied by the CLT.

According to the above embodiments of the present invention, one kind of CLTs may also be obtained. The CLTs are located in a coaxial network including at least one CLT and multiple CNUs. The CLT and each of the CNUs are connected with each other through a shared coaxial cable. Particularly, the CLT includes a downlink data transmitting unit, a control unit, a transmission time allocating unit and an uplink data receiving unit.

The uplink data receiving unit is adapted to receive uplink data transmitted by the CNUs.

The transmission time allocating unit is adapted to allocate a periodical downlink transmission period of time to the CLT and allocate a periodical uplink transmission period of time to each CNU.

The control unit is in the MAC layer, adapted to control the downlink data transmitting unit to transmit downlink data to the CNUs in each periodical downlink transmission period of time, control the downlink data transmitting unit to close during other time of a period so as to stop transmitting the downlink data and avoid collision with the uplink data transmitted by the CNUs.

The periodical uplink transmission period of time is not overlapped with the time when the CLT transmits the downlink data.

As to the above CLT, in one period, the downlink transmission time occupied by the CLT may be longer than the uplink transmission time occupied by one CNU.

The foregoing descriptions are only preferred embodiments of the present invention and are not for use in limiting the protection scope thereof. Any changes and modifications can be made by those skilled in the art without departing from the spirit of this invention and therefore should be covered within the protection scope as set by the appended claims.

1-18. (canceled)

19. A method for transmitting data, applicable to a coaxial network comprising at least one Coaxial-cable Line Terminal (CLT) and multiple Coaxial-cable Network Units (CNUs), the CLT being connected with each of the CNUs through a shared coaxial medium, comprising:
transmitting, by the CLT, a control message to each of the CNUs, wherein the control message contains information of an uplink transmission period of time that can be occupied by each CNU during one period, and uplink transmission periods of time for the CNUs are not overlapped with one another so that uplink data transmitted by the CNUs do not collide with each other.

20. The method of claim 19, wherein the CLT and the CNU work in a full-duplex mode, the CLT has a downlink coaxial channel and the CNU has an uplink coaxial channel; the control message is transmitted through the downlink coaxial channel.

21. The method of claim 20, further comprising:
detecting, by the CLT in real time, whether there are downlink data to be transmitted;
if there are the downlink data to be transmitted, transmitting, by the CLT, the downlink data respectively to the CNUs through a downlink coaxial channel;
otherwise, transmitting, by the CLT, an idle signal to the CNUs through the downlink coaxial channel or entering into a silent state.

22. The method of claim 19, wherein the CLT and each CNU work in a semi-duplex mode, and the CLT and each CNU share one channel; the method further comprises:
allocating, by the CLT, a downlink transmission period of time to the CLT itself;
wherein the downlink transmission period of time is not overlapped with the uplink transmission period of time of the CNU, and the control message is transmitted to each CNU during the downlink transmission period of time.

23. The method of claim 19, further comprising:
receiving, by the CLT from each CNU, length of the uplink data to be transmitted by each CNU;
determining, by the CLT, length of time occupied by each CNU during one period according to the number of the CNUs and the length of the uplink data to be transmitted by each CNU.

24. The method of claim 19, further comprising:
transmitting, by each CNU, the uplink data during the uplink transmission period of time corresponding to the CNU.

25. The method of claim 24, wherein the transmitting the uplink data by each CNU comprises:
detecting, by the CNU when the uplink transmission period of time corresponding to the CNU begins, whether there are the uplink data to be transmitted;
if there are the uplink data to be transmitted, transmitting, by the CNU, the uplink data to the CLT in the uplink transmission period of time corresponding to the GNU;
otherwise, transmitting, by the CNU, an idle signal to the CLT or entering into the silent state in the uplink transmission period of time corresponding to the CNU.

26. A Coaxial-cable Network Unit (CNU), located in a coaxial network comprising at least one Coaxial-cable Line Terminal (CLT) and multiple CNUs and the CLT being connected with each of the CNUs through a shared coaxial medium, comprising:
a downlink data receiving unit, a control unit and an uplink data transmitting unit;
wherein the downlink data receiving unit is adapted to receive downlink data and a control message transmitted by the CLT;
the control unit is in a Media Access Control (MAC) layer and is adapted to obtain a periodical uplink transmission period of time from the control message transmitted by the CLT, control the uplink data transmitting unit during the uplink transmission period of time in one period to start to transmit uplink data to the CLT, and control the uplink data transmitting unit during other time of the period to close and stop transmitting the uplink data so as to avoid collision with data transmitted by other CNUs.

27. The CNU of claim 26, wherein the CLT and each CNU work in a full-duplex mode, the CLT has a downlink coaxial channel and each CNU has an uplink coaxial channel, the control message is received through the downlink coaxial channel of the CLT.

28. The CNU of claim 26, wherein the CLT and each CNU work in a semi-duplex mode, the CLT and each CNU share one channel;
wherein the CLT has a downlink transmission period of time which is not overlapped with the uplink transmission period of time of the CNU, and the control message is received from the CLT during the downlink transmission period of time.

29. The CNU of claim 28, wherein during one period, the uplink transmission period of time occupied by the CNU is shorter than the downlink transmission period of time occupied by the CLT.

30. A Coaxial-cable Line Terminal (CLT), located in a coaxial network comprising at least the CLT and multiple Coaxial-cable Network Units (CNUs) and the CLT being connected with each of the CNUs through a shared coaxial medium, comprising:
a downlink data transmitting unit, a control unit, a transmission time allocating unit and an uplink data receiving unit;
wherein the uplink data receiving unit is adapted to receive uplink data transmitted by the CNUs;
the transmission time allocating unit is adapted to allocate a periodical downlink transmission period of time to the CLT and transmit a control message to each of the CNUs, wherein the control message contains information of an uplink transmission period of time that can be occupied by each CNU during one period and uplink transmission periods of time for the CNUs are not overlapped with one another so that uplink data transmitted by the CNUs do not collide with each other; and
the control unit is located in a Media Access Control (MAC) layer and adapted to control the downlink data transmitting unit in the periodical downlink transmission period of time to start to transmit downlink data to the CNUs, and control the downlink data transmitting unit during other time of the period to stop transmitting the downlink data to avoid collision with the uplink data transmitted by the CNUs.

31. The CLT of claim 30, wherein the CLT and each CNU work in a full-duplex mode, the CLT has a downlink coaxial channel and each CNU has an uplink coaxial channel; the transmission time allocating unit transmits the control message through the downlink coaxial channel.

32. The CLT of claim 30, wherein the CLT and each CNU work in a semi-duplex mode, the CLT and each CNU share one channel;
wherein the downlink transmission period of time is not overlapped with the uplink transmission period of time of each CNU; and the transmission time allocating unit transmits the control message to each CNU during the downlink transmission period of time.

33. The CLT of claim 30, wherein in one period, the downlink transmission period of time occupied by the CLT is longer than the uplink transmission period of time occupied by one CNU.
